(19) United States
(12) Patent Application Publication
(10) Pub. No.: US 2022/0374237 A1
(43) Pub. Date: Nov. 24, 2022

(54) APPARATUS AND METHOD FOR IDENTIFYING AND PRIORITIZING CERTAIN INSTRUCTIONS IN A MICROPROCESSOR INSTRUCTION PIPELINE

(71) Applicant: Telefonaktiebolaget LM Ericsson (publ), Stockholm (SE)

(72) Inventors: Mehdi Alipour, Limhamn (SE); Alexander Hunt, Tygelsjö (SE); Fredrik Dahlgren, Lund (SE)

(21) Appl. No.: 17/326,972

(22) Filed: May 21, 2021

(51) Int. Cl. G06F 9/38; G06F 9/48; G06F 9/30

(52) U.S. Cl. CPC G06F 9/3802; G06F 9/3855; G06F 9/4881; G06F 9/30145

(57) ABSTRACT

A microprocessor improves Memory Level Parallelism (MLP) with minimal added complexity and without requiring segregated storage or management of instructions, by marking memory instructions and related instructions as urgent, and dispatching marked and unmarked instructions into common queuing circuitry for scheduled execution within scheduling circuitry that is configured to prioritize the execution of marked instructions. Instruction marking may be limited to the span of the renaming stage or may be extended to the span of the reorder buffer for additional gains in MLP.

### TECHNICAL FIELD

A microprocessor and a corresponding method of operation by a microprocessor improve Memory Level Parallelism (MLP), based on an instruction-marking scheme that prioritizes scheduled execution of memory instructions and related instructions.

### BACKGROUND

Modern microprocessors exploit various techniques to improve performance by increasing on-chip parallelism. Executing multiple instructions at the same time, referred to as Instruction Level Parallelism or ILP, represents an example type of parallelism having nearly universal application, Processors capable of executing multiple instructions at the same time are called superscalar. Superscalar processors execute multiple instructions in or out of program order, where “program order” is the sequential order defined by the program according to the involved semantics and the programming model.

An in-order superscalar processor executes multiple adjacent instructions at the same time, where “adjacent” refers to the program order. An out-of-order superscalar processor also finds and executes multiple instructions at the same time, but the instructions do not have to be adjacent. The out-of-order processor operates on a “dynamic instruction window” that spans a meaningful number of program instructions. The out-of-order processor finds and executes independent instructions that are currently within the dynamic instruction window, where the parallel execution of independent instructions constitutes ILP.

The number of independent instructions included at any given time in the dynamic instruction window limits the ILP that an out-of-order processor can exploit. Some programs have more intrinsic ILP than others. The lack of ILP in a program leads to hardware underutilization. For example, fewer independent instructions within the span of the instruction window limits the ability of instruction-execution “scheduler” to dispatch instructions in parallel for execution, Further, cache misses, where data needed to execute an instruction is not resident in local cache memory may result in relatively long “stalls” that affect the entire processor for multiple cycles. Other causes of stall include branch misprediction, where speculative-execution circuitry of the microprocessor guesses incorrectly as to which program branch will be taken.

Simultaneous Multithreading (SMT) at least partly addresses the problem of hardware underutilization by executing multiple instructions not only at the same time but also from independent program threads within one or more programs. In SMT, multiple instruction threads use the same hardware and share it either statically or dynamically. As a result of sharing, when one of the threads does not have enough ILP to utilize the hardware, the other threads act as a backup to provide adequate ILP, thorough Thread Level Parallelism or TLP.

Another form of parallelism in SMT processors and other types of processors is Memory Level Parallelism or MLP, which refers to a processor making concurrent memory requests. Making memory requests in parallel helps compensates for latencies associated with memory accesses. For example, memory instructions that involve cache misses require additional time. Serial memory requests involving cache misses impose separate waiting times. Contrastingly, concurrent memory requests involving cache misses have overlapping wait times, thus reducing the aggregate wait time.

Known approaches to improving MLP in processors are “resource centric.” For example, a typical approach relies on increasing the size of out-of-order resources in the processor. Expanding the size of such resources, such as expanding the size of the out-of-order execution window, increases the opportunity for MLP, but comes at the obvious “expense” of increased circuit area and power consumption. Further, increasing the out-of-order resources may require lowering the operating frequency for reliable operation, with a corresponding possible degradation of the overall performance of the processor.

Another known, resource-centric approach to improving MLP involves the use of multiple instruction queues, such as a high-priority queue to hold instructions given higher priority by an MLP-aware scheduler, and a low-priority queue to hold instructions given lower priority by the MLP-aware scheduler, Exploiting MLP in this manner offers performance improvements but requires the use of additional queue circuitry, which characteristically is expensive in terms of its complexity, power consumption, and size.

### SUMMARY

A microprocessor improves Memory Level Parallelism (MLP) with minimal added complexity and without requiring segregated storage or management of instructions, by marking memory instructions and related instructions as urgent, and dispatching marked and unmarked instructions into common queuing circuitry for scheduled execution within scheduling circuitry that is configured to prioritize the execution of marked instructions. Instruction marking may be limited to the span of the renaming stage or may be extended to the span of the reorder buffer for additional gains in MLP.

According to an example embodiment, a microprocessor comprises an instruction pipeline that includes front-end circuitry that is configured to fetch instructions, decode instructions, perform register renaming in association with instructions, and dispatch instructions for scheduled execution. The front-end circuitry is further configured to set an urgency indicator for each instruction identified during decoding as a memory instruction and set urgency indicators for related instructions identified during register renaming. An instruction is “related” to a memory instruction if its execution is necessary for execution of the memory instruction. Scheduling circuitry of the instruction pipeline is configured to control out-of-order instruction execution of instructions dispatched by the front-end circuitry, in dependence on the urgency indicators.

In another embodiment, an apparatus includes a microprocessor according to the above description. The apparatus is a smartphone, for example. In other examples, the apparatus is a personal computer or a tablet.

In yet another embodiment, a method performed by a microprocessor comprises identifying memory instructions during decoding of instructions fetched into an instruction pipeline of the microprocessor for scheduling and corresponding out-of-order execution and setting urgency indicators for the memory instructions. For each memory instruction, the method further includes identifying related instructions during register renaming and setting urgency indicators for the related instructions. Still further, the method includes dispatching instructions after decoding and register renaming, for scheduling of out-of-order execution and controlling the out-of-order execution of dispatched instructions, in dependence on the urgency indicators.

Of course, the disclosed subject matter is not limited to the above features and advantages, Those of ordinary skill in the art will recognize additional features and advantages upon reading the following detailed description, and upon viewing the accompanying drawings.

### BRIEF DESCRIPTION OF THE DRAWINGS

FIG. 1 is a block diagram of a microprocessor, in an example embodiment.

FIGS. 2a and 2b are block diagrams of an example load/store slice.

FIG. 3 is a block diagram of a microprocessor, in another example embodiment

FIG. 4 is a logic flow diagram of a method performed by a microprocessor, in an example embodiment.

FIG. 5 is a block diagram of example processing details for an instruction pipeline of a microprocessor, according to an example embodiment.

FIG. 6 is a block diagram of register renaming elements, including an architectural register file, according to an example embodiment.

FIG. 7 is a diagram illustrating example usage and relations for urgent instruction marking and handling, according to an example embodiment.

FIG. 8 is a block diagram of a back-pointer structure of a microprocessor that is configured for urgency marking of instructions, according to an example embodiment.

### DETAILED DESCRIPTION

From the perspective of a general instruction scheduler, all instructions are equally important when it comes to execution. A main emphasis in such schedulers is issuing and executing ready-to-execute instructions as soon as possible. Upon finding such instructions, a general scheduler issues one or more of them to the functional units, according to their age. “Age” refers to the time spent in the Instruction Queue (IQ), for example, or may refer to the program order that establishes the sequential order of the instructions being fetched into the microprocessor for execution.

However, different instructions have different impacts on performance. Some instructions will improve performance if their scheduling is expedited in relation to others, while other instructions can be delayed without any negative impact on performance. Oldest-first instruction scheduling policy does not consider such differences in performance impact.

Because memory instructions involve the possibility of cache misses that require waiting, they have a large potential effect on overall instruction throughput of a microprocessor. Accordingly, improving Memory Level Parallelism (MLP) is key to improving performance, but is challenging to accomplish without adding significant additional resources to the involved microprocessor. As explained earlier, MLP refers to the execution of memory instructions in overlapping fashion, so that any waiting times associated with the respective memory instructions at least partly overlap, rather than being experienced in strict serial fashion.

In the context of improving MLP, which is one aspect of the techniques disclosed herein, memory instructions are considered urgent, and the instructions that must be executed to execute the memory instructions are also considered urgent, by relation. Consider an example classification of low-level pseudo-code instructions representing a program loop. The example pseudo-code comprises instructions for comparing elements of two arrays (ArrayA and ArrayB) and writes the smaller element from each comparison to a third array (ArrayC). The comment section of the code describes what each instruction does, and the urgency-related categorization is also shown.

| | | | Urgency |
|---|---|---|---|
| | Instruction | Comment | Marking |
| 1 | Index = 0 | Set the array index to zero (first array element) | Non-urgent |
| 2 | R5 = num-iteration | Set the number of loop iterations | Non-urgent |
| | LOOP | A label marking the start of the loop | |
| 3 | MemReg = arrayA + | Read the address of ArrayA element into the | Urgent |
| | index | memory register | |
| 4 | R1 = memory- | Read a copy of arrayA element into a | Urgent |
| | read(MemReg) | computation register | |
| 5 | MemReg = arrayB + | Read the address of ArrayB element into the | Urgent |
| | index | memory register | |
| 6 | R2 = memory- | Read a copy of ArrayB element into a | Urgent |
| | read(MemReg) | computation register | |
| 7 | MemReg = arrayC + | Read the address of arrayC element into the | Urgent |
| | index | memory register | |
| 8 | R3 = MemReg | Write the address of the current element of | Urgent |
| | | arrayC into a computational register | |
| 9 | CMP R1, R2 | Compare corresponding elements of arrayA | Non-urgent |
| | | and arrayB | |
| 10 | JLE L1: | Jump to Label “L1” if R1 <= R2, otherwise, go | Non-urgent |
| | | to next line | |
| 11 | R2 = memory- | Write R2 into a memory location with the | Urgent |
| | write(R3) | address of R3 (current element of ArrayC) | |
| 12 | Jmp Next-Iteration: | Jump to Next-Iteration label | Non-urgent |
| | L1: | A label | |
| 13 | R1 = memory- | Write R1 into a memory location with address | Urgent |
| | write(R3) | of R3 (current element of ArrayC) | |
| | Next-Iteration | A label | |
| 14 | index = index + 1 | Update the index to point to next element | Non-urgent |
| 15 | R5 = R5 − 1 | Update the loop iteration | Non-urgent |
| 16 | CMP Loop-iteration, 0 | Compare the current value of loop-iteration | Non-urgent |
| | | with zero | |
| 17 | JG LOOP; | If loop-iteration > zero, go to label LOOP and | Non-urgent |
| | | perform another iteration, otherwise go to next | |
| | | line (END) | |
| 18 | End; | END of the program (completion of loop | |
| | | iterations) | |

The above instruction classifications (Urgent versus Non-urgent) derive from marking memory instructions, e.g., the load instructions as urgent, and also marking the instructions needed to determine the load addresses as urgent. Regarding the specifics of the example low-level instructions, any direct or implied connection to the so-called “x86” machine architecture, as originated by INTEL, does not mean that the techniques disclosed herein are limited to the x86 architecture. Indeed, the disclosed techniques have broad applicability.

In disclosed embodiments of a microprocessor or method of operation by a microprocessor, elements within an instruction pipeline of the microprocessor carry out the marking, while other elements prioritize execution based on the markings. Here, “element” refers to a functional circuit within the microprocessor, and “marking” an instruction as urgent comprises, for example, setting an already-available instruction bit, e.g., a reserved bit, as an indication of urgency. Thus, instructions with the bit set are recognized as urgent and instructions without the bit set are not so recognized. More than one bit may be used, e.g., to provide for multiple levels of urgency.

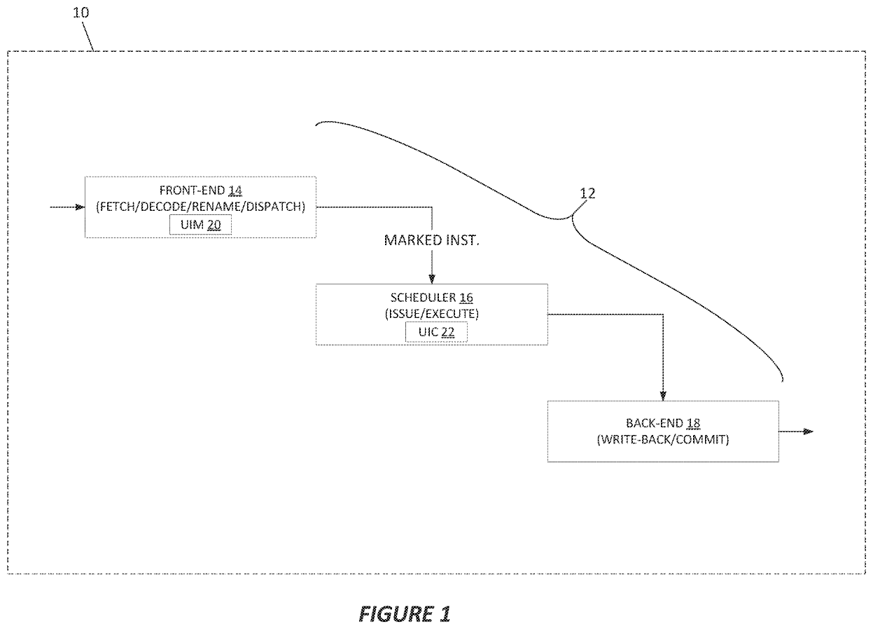

FIG. 1 depicts a microprocessor 10 according to an example embodiment, where the microprocessor 10 implements an instruction-urgency scheme for improved MLP and does so without need for separate dispatching or queuing of urgent versus non-urgent instructions, and also without expanding the size of the instruction window. The example microprocessor 10 includes an instruction pipeline 12 that comprises front-end circuitry 14, scheduling circuitry 16, and back-end circuitry 18.

The front-end circuitry 14 includes urgent-instruction marking (UIM) circuitry 20 that marks urgent instructions. Here, the term “urgent” refers to improving MLP, in that expedited scheduling of urgent instructions increases the MLP and thereby reduces the overall time the microprocessor 10 spends waiting as a consequence of cache misses, etc. Correspondingly, the scheduling circuitry 16, which provides out-of-order (OOO) scheduling of instruction execution, includes urgent-instruction control (UIC) circuitry 22, that prioritizes scheduling of urgent instructions. The back-end circuitry 18 provides write-back/commit operations for executed instructions.

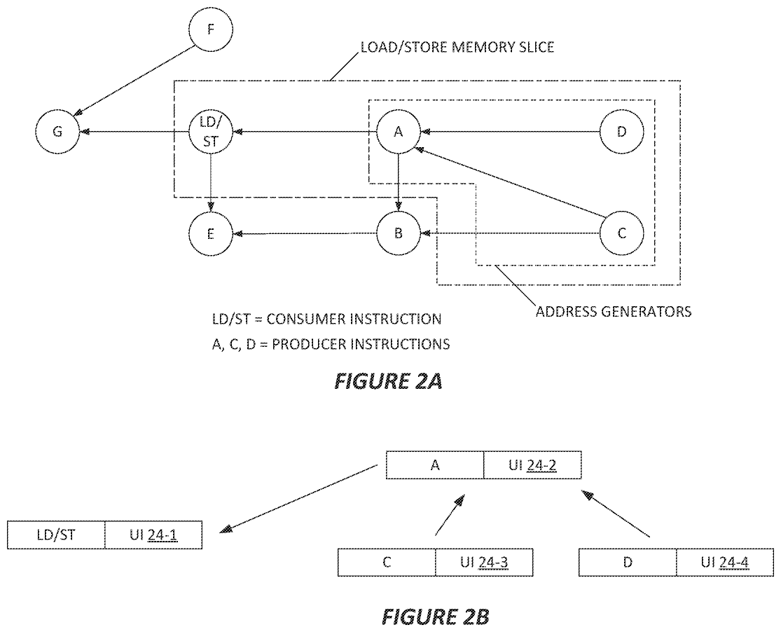

FIG. 2A provides an example of urgent-instruction marking, in the context of a load/store memory “slice” that comprises a load or store (load/store or LD/ST) instruction and the instructions that are related to the load/store instruction. In the example diagram, in addition to the load/store instruction, the other instructions include instructions A, B, C, D, E, F, and G, where the letters are simply labels of convenience for the respectively illustrated instructions.

The load/store instruction targets a memory address, and the instructions A, C, and D are “address generators” because the load/store address is obtained by executing the A, C, and D instructions. FIG. 2B illustrates an example of urge-instruction marking for the load/store memory slice shown in FIG. 2A, with the load/store instruction having an urgency indicator (UI) 24-1, and the related instructions A, C, and D having UIs 24-2, 24-3, and 24-4.

In at least one embodiment, all instructions are defined to have one or more reserved bits and the microprocessor 10 in one or more embodiments is configured to use one or more of the reserved positions as the UI 24. Reserved bits are zero or set by default, for example and of need not be manipulated unless a given instructions needs to be marked as urgent. Thus, the microprocessor 10 selectively marks individual instructions as urgent by setting the targeted reserved bit(s) in each such instruction. When more than one reserved bit is used to indicate urgency, the microprocessor 10 can set different levels of (relative)urgency, by choosing which bits are set.

Whether single-bit or multi-bit UIs 24 are used, the front-end circuitry 14 of the instruction pipeline 12 is configured to fetch instructions, decode instructions, perform register renaming in association with instructions, and dispatch instructions for scheduled execution. The front-end circuitry 14 is further configured to set a UI 24 for each instruction identified during decoding as a memory instruction and set UIs 24 for related instructions identified during register renaming. The scheduling circuitry 16 of the instruction pipeline 12 is configured to control out-of-order instruction execution of instructions dispatched by the front-end circuitry 14, in dependence on the urgency indicators UIs 24. Here, “controlling” the out-of-order execution comprises, for example, prioritizing execution of an instruction that is marked as urgent over an instruction that is not marked as urgent.

With respect to any particular memory instruction identified during decoding, the related instructions comprise any instructions within a defined program distance from the particular memory instruction that produce a result that is needed directly or indirectly for execution of the particular memory instruction. “Program distance” refers to the number of intervening instructions, in the sequence of instructions comprising the program.

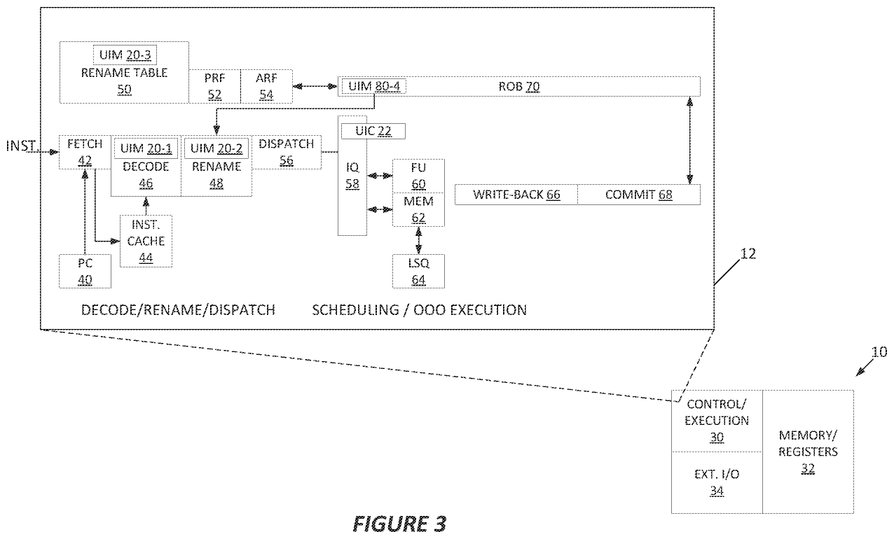

FIG. 3 illustrates example details for the microprocessor 10 and its instruction pipeline 12, according to one embodiment. Included in the microprocessor 10 are control/execution circuitry 30, memory/registers 32, and external input/output (I/O) 34.

The instruction pipeline 12 exists within the control/execution circuitry 30 and it includes a number circuits, which may be referred to as units or blocks. The various circuits include a program counter (PC) unit 40, an instruction fetching unit 42, an instruction cache 44, a decoding unit 46, a register renaming unit 48, a register renaming table 50, physical register file (PRF) 52, architectural register file (ARF) 54, a dispatching unit 56, an instruction queue (IQ) 58, one or more functional units 60 (e.g., adders, multipliers, etc., for instruction execution), memory 62, a load/store queue (LSQ) 64, a write-back unit 66, a commit unit 68, and a reorder buffer (ROB) 70 that holds the span of instructions currently in the pipeline 12.

As seen in the diagram, the various units or blocks are organized into successive “stages” of operation. Because the instruction pipeline 14 is organized in “stages,” e.g., the fetching stage, the decoding stage, the dispatching stage, and the scheduling/execution stage, the decoding unit 46 may be referred to as the “decoding stage”, the register-renaming unit 48 may be referred to as the “renaming stage”, and so on.

The instruction fetching unit 42 fetches individual instructions from a programmed sequence of instructions, according to the value of the instruction pointer held in the PC unit 40, which is updated for each successive fetching operation. Operations in the decoding unit 46 include decoding fetched instructions and recognizing or detecting memory instructions and marking them as urgent. The decoding unit 46 includes UM circuitry 20-1 that is configured for such detection and marking. With the decoding unit 46 setting UIs 24 for memory instructions, the renaming unit 48 receives (decoded) instructions from the decoding unit 46, with the memory instructions incoming to the renaming unit 48 being marked as urgent. The renaming unit 48 identifies instructions related to each memory instruction and marks those related instructions as urgent, via UIM circuitry 20-2 in the renaming unit 48.

The dispatching unit 56 dispatches instructions, both marked and unmarked, to the IQ 58, which includes UIC circuitry 22 that is configured to control out-of-order execution of instructions based on urgency—i.e., as between marked and unmarked instructions and all other factors being equal, the IQ 58 prioritizes execution of marked instructions. In instances that use multiple levels of urgency—e.g., multi-bit UIs 24—the UIC circuitry 22 is configured to give greater execution priority to marked instructions having higher indicated urgency, as compared to marked instructions having lower indicated urgency. Overall scheduling of out-of-order execution carried out by the IQ 58 may consider multiple factors when scheduling, with the urgency marking described herein being one such factor.

The “program distance” considered when marking memory instructions and related instructions as urgent is at least the width of the register renaming unit 48 included in the front-end circuitry 14, such that the front-end circuitry 14 is configured to look for related instructions at least within the register renaming unit 48. “Program distance” refers to the separation between instructions within the ordered program sequence being processed by the instruction pipeline 12.

In at least one embodiment, the program distance over which related-instruction marking occurs extends to instructions already dispatched by the front-end circuitry 14 and held in a reorder buffer (ROB) 70 used by the scheduling circuitry 16 for the out-of-order program execution. Instructions h&d in the ROB 70 may be considered to be “in flight” instructions within the pipeline 12, and the front-end circuitry 14 is configured to set UIs 24 for instructions in the ROB 70 that are identified as related instructions for the particular memory instruction and are determined to be pending for execution. That is, the ROB 70 may hold instructions that have already been executed, such that urgency marking them is moot. UIM circuitry 80-4 in or associated with the ROB 70 provides for urgency marking of related instructions within the ROB 70.

Extending the program distance in this manner allows the microprocessor l0 to detect or otherwise identify related instructions for a given memory instruction currently in the renaming unit 48, from among the instructions held within the renaming space or held within the instruction space of the ROB 70. Notably, none of the underlying registers or other storage elements within the pipeline 12 need he increased in size or managed separately for urgent versus non-urgent instructions, with the UIs 24 carried, for example, within one or more of the reserved bits natively included in each instruction. As noted, load/store instructions are a type of memory instruction, such that the front-end circuitry 14 is configured to set a UI 24 for each load/store instruction identified during decoding, and to set UIs 24 for each instruction identified by the front-end circuitry 14 as being related.

The IQ 58, which comprises storage elements used by the scheduling circuitry 16 for holding instructions for out-of-order program execution, is common between instructions having set UIs 24 and instructions having cleared UIs 24. That is, instructions marked as urgent and those not so marked used the same IQ 58. A “cleared” UI 24 is one that has not been set and does not necessarily require an affirmative action. For example, in an implementation where individual instructions have one or more reserved bits that repurposed or allocated for use as UIs 24, such bits may be zero or cleared by default, meaning that the default state or condition of an instruction is “non-urgent” in the context of urgent/non-urgent described herein. In this scenario, the pipeline circuitry of the microprocessor 10 need only “set” the reserved bit(s) of memory instructions and related instructions to mark them as urgent.

In any case, the scheduling circuitry 16 is configured to consider whether instructions have set or cleared urgency indicators when scheduling instructions for out-of-order execution. The scheduling circuitry 16 prioritizes execution of instructions that are marked as urgent versus those not marked as urgent, at least when any other factors or considerations affecting scheduling are equal between the competing instructions. The UIs 24, as noted for one or more embodiments, each comprise one or more bits that are selectively set for respective instructions in the pipeline 12, and where the front-end circuitry 14 is configured to clear or not set a corresponding one of the UIs 24 for a particular instruction not identified as urgent, and to set a corresponding one of the UIs 24 for another particular instruction identified as urgent. Here, in embodiments where the UIs 24 are one or more reserved bits carried in each instruction, the UI 24 corresponding to an instruction is/are the reserved bit(s) in the instruction that are allocated for urgency-indication use.

The UIs 24 in at least one embodiment are multi-bit indicators and the front-end circuitry 14 is configured to set the UI 24 to one of multiple defined values, e.g., combinatorial values, to indicate a degree of urgency. The scheduling circuitry 16 is configured to consider the degree of urgency during scheduling. In an example case, with all other considerations or factors affecting execution being equal, as between two instructions marked as urgent, with a first one having a higher urgency marking than the second one, the scheduling circuitry 16 prioritizes the first one.

For each memory instruction identified during decoding, the front-end circuitry 14 is configured to set UIs 24 for all instructions that arc identified as being related to the memory instruction and have a program distance from the memory instruction that is within the program distance spanned by the register renaming unit 48 of the front-end circuitry or within the overall program distance spanned by ROB 70 used by the scheduling circuitry 16 for out-of-order execution.

The microprocessor 10 is comprised in, for example, an apparatus. Examples of the apparatus include a smartphone, a personal computer, and a tablet. Such devices may be understood as example computing devices that embed or otherwise include a microprocessor 10 that provides improved MLP according to the instruction-marking and execution control disclosed herein.

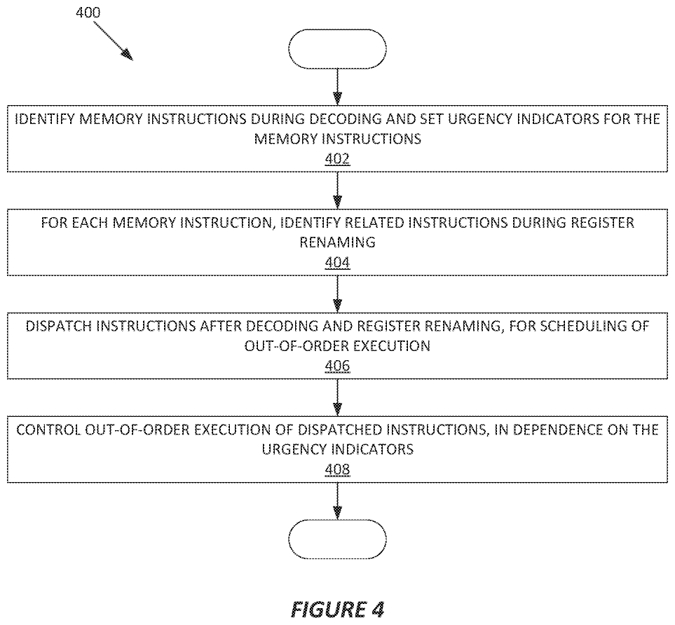

Another embodiment of the technique(s) disclosed herein for improving MLP comprises a method 400 performed by a microprocessor 10, as shown in FIG. 4. The method 400 includes identifying (Block 402) memory instructions during decoding of instructions fetched into an instruction pipeline 12 of the microprocessor 10 for scheduling and corresponding out-of-order execution and setting UIs 24 for the memory instructions. For each memory instruction, the method 400 includes identifying (Block 404) related instructions during register renaming and setting UIs 24 for the related instructions, wherein an instruction is related to a memory instruction if execution of the instruction is necessary for execution of the memory instruction. Further, the method 400 includes dispatching (Block 406) instructions after decoding and register renaming, for scheduling of out-of-order execution, and controlling (Block 408) the out-of-order execution of dispatched instructions, dependence on the urgency indicators (24).

With respect to any particular memory instruction identified during decoding, the related instructions comprise any instructions within a defined program distance from the particular memory instruction that produce a result that is needed directly or indirectly for execution of the particular memory instruction. The program distance is at least the width of a register renaming unit 48 included in the instruction pipeline 12, such that the identifying of related instructions occurs at least within the register renaming stage of the instruction pipeline 12. In at least one embodiment, the program distance extends to instructions already dispatched for execution and held in a ROB 70 used by scheduling circuitry 16 of the instruction pipeline 12 for the out-of-order program execution. Identifying (Block 404) related instructions in such embodiments includes identifying related instructions in the ROB 70 that are pending for execution.

Identifying (Block 402) memory instructions comprises, for example, identifying load/store instructions. As noted before, “load/store” denotes load and/or store. Continuing the example, identifying (Block 404) related instructions comprises identifying instructions on which the load/store instructions depend.

Advantageously, storage elements, e.g., the IQ 58, used by scheduling circuitry 16 of the instruction pipeline 12 for holding instructions for out-of-order program execution are common between instructions having set UIs 24 and instructions having cleared UIs 24. A “cleared” UI 24 also may be regarded as not having a UI 24, such that urgent instructions may be understood as having UIs 24 and ion-urgent instructions may be regarded as not having UIs 24.

The UIs 24 may be multi-bit indicators. Setting the UI 24 in a multi-bit example for an instruction identified as urgent comprises setting the UI 24 to one of multiple defined values, to indicate a degree of urgency. An example two-bit UI 24 comprises [bit 1, bit 0], where bit 1 is the most-significant bit, and where [0, 0] is not urgent. The value [0, 1] is a first level of urgency, [1, 0] is a second level of urgency, and [1, 1] is a third level of urgency. Again, these bits may come for “free” as reserved bits within the individual instructions that are available for repurposing as UIs 24, and the [0, 0] condition may be the default state.

For each memory instruction identified during decoding, the method 400 further includes setting UIs 24 for all instructions that are identified as being related to the memory instruction and have a program distance from the memory instruction that is within the program distance spanned by a register renaming unit 48 of the instruction pipeline 12 or, in at least one embodiment, within the program distance spanned by a ROB 70 used in the instruction pipeline 12 for out-of-order execution.

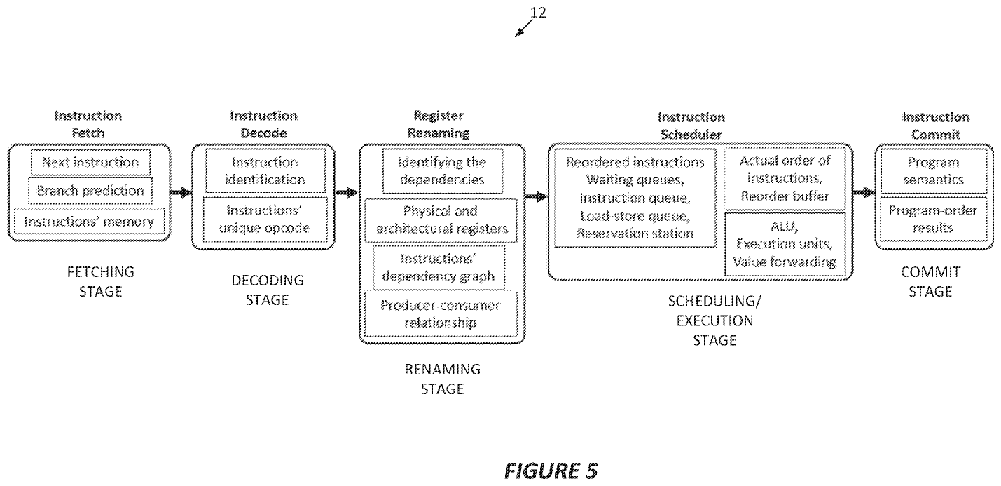

FIG. 5 illustrates another representation of an example instruction pipeline 12 of a microprocessor 10, with emphasis on the aforementioned “stage” arrangement. The instruction fetching stage includes determining the memory location of the next instruction and fetching the next instruction, including accounting for branch predictions. The decoding stage decodes (fetched) instructions into their respective opcodes and includes identifying memory instructions and marking them as urgent.

The renaming stage receives (decoded) instructions and includes register renaming to remove artificial dependencies. For memory instructions—marked as urgent by the decoding stage the renaming stage identifies related instructions, e.g., by determining dependencies in terms of “producer/consumer” relationships. A “producer” instruction produces a result that is used by a “consumer” instruction. For example, a load/store instruction “consumes” an address resulting from the execution of another instruction, such that the other instruction is a “producer” with respect to the load/store instruction.

The scheduling/execution stage involves the IQ 58, the LSCS 54, the function units 60, memory 62, ROB 70, etc., shown in FIG. 3, and provides for scheduling and executing instructions dispatched into the scheduling/execution stage. Particularly, the scheduling/execution stage includes the UIC 22 shown in FIG. 3, and controls instruction execution to prioritize the execution of instructions that are marked as urgent—i.e., have “set” UIs 24. The commit stage holds the results of executed instructions, and those results may be dump as a consequence of exceptions, page faults, etc. Once all dependencies are resolved, the write-back stages writes the execution results from the commit stage into the appropriate registers.

With the above in mind, microprocessor 10 according to one or more embodiments includes an instruction decoding stage that is configured to interpret the encoded instructions into control signals decoded instructions that indicate what actions the microprocessor 10 has to take according to each of the instructions and also hardware required to accomplish those actions.

Further, a register renaming stage of the microprocessor 10 is configured to identify the different dependencies between instructions, for example producer-consumer dependencies. A first and a second type of instructions are labeled as urgent by setting bits as part of operations in the instruction decoding stage and/or the register renaming stage. The first type of instructions is memory instructions, such as load instructions and/or store instructions (abbreviated as load/store or LD/ST instructions). In some embodiments, the instruction decoding stage is configured to identify instructions of the first type and label them as urgent. Alternatively, in some embodiments, if the decode and register renaming stages are merged into a single stage, the register renaming stage is configured to identify instructions of the first type and label them as urgent. The second type of instructions are instructions that have an interdependency with the identified instructions of the first type. Dependencies include the instructions that are directly or indirectly producers for the first type instructions. For example, an instruction that generates an address for a load/store instruction fits into this type.

In some embodiments, the register renaming stage is configured to identify instructions of the second type and label them as urgent. For example, the register renaming stage may be configured to identify instructions of the second type in response to an instruction of the first type entering the register renaming unit. As a result, urgent instructions can be identified early in the instruction pipeline of the microprocessor 10, before being scheduled for execution, at a hardware overhead which is very low relative to solutions for improving MLP that rely on adding storage resources to the pipeline for handling instructions that are urgent in the MLP sense.

The disclosed arrangements offer what amounts to a storage-free approach to handling instructions for storage-free improvements of MLP and depend on identifying and marking urgent instructions at the decoding and register renaming stages of the processor pipeline 12. Advantageous considerations include the distance (instruction count in program execution order) between memory instructions and the related instructions—i.e., between address generators and address consumers—and the corresponding recognition that related instructions are often adjacent to or within a relatively short program distance of the memory instructions to which they relate. Often, the program distance between a memory instruction and the instructions on which it depends is less than the width of the register renaming stage.

Consequently, a given memory instruction and its related instructions are often “renamed” at the same time (or within the same “set” of renaming operations) within the renaming stage. Identifying memory instructions and marking them as urgent at the decoding stage allows, without additional storage or hardware cost, the renaming stage to mark as urgent any instructions within the renaming space of the renaming stage that are identified as being related to a memory instruction currently within the renaming stage.

Rather than adding additional storage resources for instructions that are urgent in a MLP sense, the techniques disclosed herein rely on “labeling” such instructions as urgent, with the scheduling/execution stage being configured to consider the urgency markings or labels when scheduling instructions for execution. The UIs 24 or, more broadly, “urgency labels” can be used to implement any urgent-ware scheduling that accounts for prioritization, without requiring substantive changes to the underlying pipeline architecture. Advantageously, the disclosed techniques “place” the urgency labels on instructions early in the pipeline, such that instructions are evaluated and selectively marked in terms of the MLP urgency, before being dispatched into the scheduling/execution stage(s) of the instruction pipeline 12. Here, “MLP urgency” is another way of referring to the overarching goal of improving MLP, by prioritizing the execution of memory instructions and the instructions that are related to those memory instructions.

The disclosed technique(s) provide a robust mechanism for marking memory instructions as urgent and correspondingly marking all predecessor instructions—i.e., all related instructions—within a certain program distance. In an example configuration, the program distance covered is the width of the register renaming stage. In another example configuration, the program distance covered extends to the width of the ROB. For related instructions outside of the renaming stage but within the span of the ROB, a “renaming map” may be relied upon, with the understanding that register renamning map keeps track of producer-consumer dependencies for all instructions in the ROB.

In pipelines supporting out-of-order execution, renaming maps and ROBs are already included, meaning the modifications disclosed herein require almost no added circuitry. That is, the disclosed technique(S) exploit the dependency information inherently provided by the renaming map and the ROB, for identifying the predecessors of a memory instruction, such that the memory instruction and its (unexecuted) predecessors are easily identified and marked as urgent for prioritized scheduling/execution in the scheduling/execution stage.

A corresponding advantageous recognition herein is that, if the program distance between an urgent instruction and a related instruction is larger than the distance covered by the ROB, the effort of identifying and prioritizing the related instruction is not worthwhile.

While microprocessors that support out-of-order execution offer the basis for exploiting Instruction Level Parallelism (ILP), which refers to simultaneous or overlapping execution of independent instructions for improved instruction throughput, improving MLP remains challenging. The disclosed techniques) offer significant improvement in MLP without adding costly additional storage resources to the instruction pipeline. Indeed, the disclosed technique(s) offer improved MLP in both out-of-order and in-order instruction pipelines, although the overall advantages may be amplified in the context of out-of-order execution. The particular extent of performance gains realized through the incorporation of the disclosed technique(s) depends on the extent to which the involved microprocessor benefits from or is capable of exploiting MLP.

In the context of at least one embodiment, the technique(s) disclosed herein can be understood in part as a mechanism for the front-end circuitry 14 of an instruction pipeline 12 of a microprocessor 10 for providing “hints” to the instruction scheduler that operates downstream in the pipeline 12. These “hints” in the form of UIs 24, for example, indicate to the downstream scheduler 16 in the pipeline 12 that prioritizing execution of certain instructions will improve MLP. If the scheduler operates as an in-order scheduler, the hints can be understood as improving “look-ahead” operations. If the scheduler operates as an out-of-order scheduler, the hints add a further dimension to the out-of-order scheduling, allowing the scheduler to improve MLP by prioritizing the marked instructions in out-of-order execution.

In the out-of-order execution context, the ROB keeps the original sequential order among instructions. Preserving the order of the program in ROB, enables the scheduler 16 to schedule and execute instructions out-of-order. The ROB can be viewed as a “window” that moves dynamically over the sequence of program instructions, from the first one (oldest) to the last one (youngest). The ROB “size” indicates the number of entries in the ROB and defines the size of dynamic program window in modern out-of-order microprocessors. In practice, a microprocessor can only process the instructions that are inside the program window. In fact, instructions that are not inside the program window are not “visible” to the microprocessor.

Of course, ROBs represent one type of structure that may he used within a microprocessor. Alternative structures include so called “reservation stations” and “register update units” or “RUUs” and the disclosed technique(s) are applicable to all such alternatives. That is, illustration of the ROB 70 in FIG. 3 should be understood as one embodiment. The disclosed technique(s) are applicable to out-of-order microprocessors with or without ROBs and are also applicable to in-order microprocessors.

However, for better understanding of the example case depicted in FIG. 3, the LSQ 64 keeps the program order and dependencies and data forwarding associated with memory instructions, such as load instructions and store instructions. Further, the IQ 58 is where instructions wait for their operands to become ready. When all (typically two) operands of an instruction are ready, the instruction is “ready for execution”. For issuing “ready” instructions for execution, the IQ 58 considers priorities(for example oldest first), selects a few among the ready-for-execution instructions and issues them to the functional units 60 for execution. In this disclosure, the considered priorities include the urgency markings added in the front-end circuitry 14, for improved MLP.

At the execution stage, as the name suggests, instructions are executed. The operations from dispatching to completion of the issuing operations, sometimes including the execution stage itself, is referred to as “instruction scheduling”. The write-back stage, as represented by the write-back circuitry 66 in FIG. 3, is where results are written to the appropriate storage, such as memory 62 or other registers, depending on the nature of the instructions. The commit stage, as represented by the commit circuitry 68 in FIG. 3, is where the instructions are “retired”. That is, at the end of the pipeline 12, the instructions will release all occupied resources in program order.

Further, in out-of-order processors, there are two sets of registers, the PRF and the ARF, such as the PRF 52 and the ARF 54 seen in FIG. 3. The architectural registers are visible to programmers and they can directly write and read from them while the physical registers are not visible to programmers. Because of hardware constraints, the architectural registers are limited in number and, therefore, programmers have to reuse them frequently for writing and saving new results. Unless the problem is mitigated, the frequent reuse of the architectural programs cause pipeline stalls, because the pipeline has to wait for all the consumers of a value stored in one of the register to read the register, before the register can be used for any new storage. Register renaming mitigates the problem because it abstracts the architectural registers using physical registers. For example, two instructions that depend on the same architectural register according to the program logic can be made independent by making those instructions depend on two different physical registers.

There are four types of architectural-register dependencies between instructions. Read-After-Read (RAR), Read-After-Write (RAW), Write-After-Read (WAR), and Write-After-Write (WAW). Among all of these depepencies/reuses, RAW can be understood as a “true” dependency because it involves a direct, producer/consumer dependency. The other dependencies/reuses are “false” dependencies because they result merely from reuse of the same architectural register(s) between otherwise unrelated instructions. Register renaming eliminates and removes these false dependencies,

In more detail, register renaming comprises three tasks, (1) reading the source operands, (2) allocating the destination register, and (3) register updating. Reading the source operands includes identifying the operands and fetching them. Identifying occurs at the rename stage (or in decode).

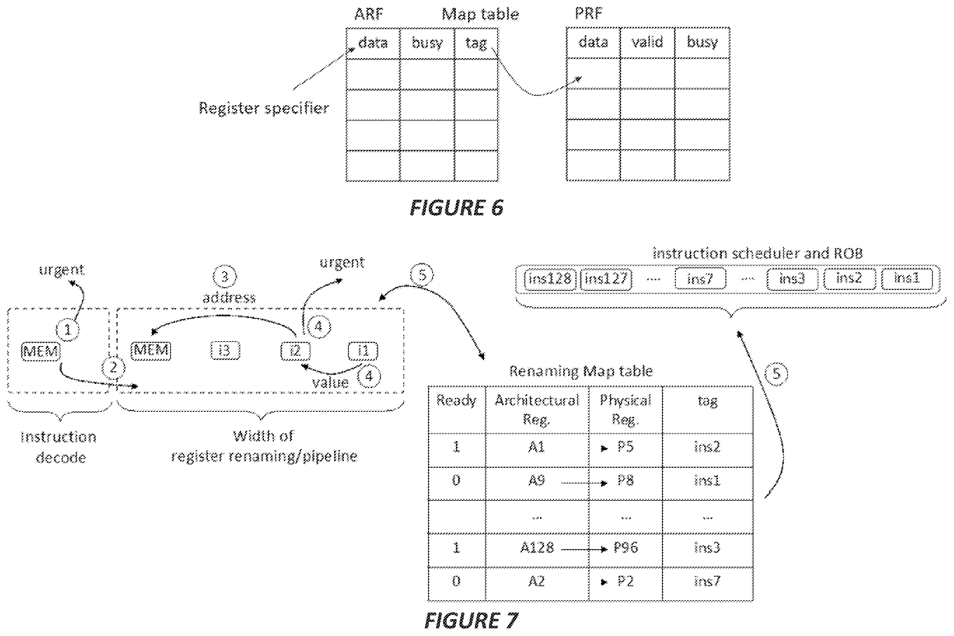

FIG. 6 depicts an overview of an example ARF and PRF. After identifying the input operands of instructions, register renaming (RR) logic within the microprocessor 10 tries to fetch them from the ARF. If the busy bit(s) is/are zero, they are ready, and the RR logic reads them. Otherwise, when the busy bit(s) is/are set, the corresponding entries have been renamed and can be found in the PRE using “tags”. Each tag is metadata that connects an entry in the ARF to an entry in the PRF.

Destination registers, the registers where instructions write their results are always renamed. When renaming a destination register, a tag is assigned and will be shared with the new consumer instructions to inform them that their operand comes from a register in the PRF instead of from a register in the ARF. The connections between the ARF and the PRF, i.e., the tags, are stored in the renaming table as shown in the figure. The register renaming table also may be referred to as a register aliasing table, because it remaps the architectural register names in the decoded instructions to respective physical register names.

Because register renaming operations identify the producer-consumer dependencies between instructions, marking memory instructions with UIs 24 in the decoding stage provides an elegant mechanism for marking related instructions in the renaming stage. Particularly, in each cycle of operation by the decoding stage, it can identify memory instructions via their opcodes and mark such instructions as urgent before they enter the renaming stage.

FIG. 7 illustrates example functionality regarding urgent-instruction marking for unproved MLP. A memory (“MEM”) instruction is identified in decoding and marked as urgent (Step 1). At Step 2, the MEM instruction passes to the renaming stage, which contains additional instructions i1, i2, and i3. Register-renaming operations identify instructions i1, and i2 but not i3 as being related to the MEM instruction. Particularly, instructions i1 and i2 are address generators with respect to the MEM instruction. Thus, instructions i1 and i2 are marked as urgent, as part of the renaming operations.

In more detail, in the example of FIG. 7, the instruction i2 is a direct address generator for the MEM instruction. Instruction i2 is dependent on instruction i1, meaning that the instruction i1 is a “producer” with respect to the instruction i2, and is, therefore, an indirect address producer for the MEM instruction. Thus, both instructions i1 and i2 are identified as urgent and marked—e.g., UIs 24 are set in both instructions.

For identifying urgent instructions outside of the renaming space, a renaming map table used for register-renaming operations may be exploited to identify dependencies for instructions within the dynamic window of the ROB. That is, when identifying related instructions beyond the renaming space of the renaming stage, the renaming map table may be utilized to identify related instructions that are currently in the ROB and pending for execution. In the example renaming map table, In the example renaming map table, the combination of “Ready” and “valid” bits can indicate whether an instruction currently in the ROB has executed, and urgency-marking is limited to related instructions that have not already executed.

An example microprocessor 10 may already include/use a “back-pointer” from the renaming map table to the scheduler, for indexing or other purposes. Urgent-instruction identification in the ROB may be configured to exploit such a back-pointer. For example, such a back-pointer is used to send a signal to the ROB, indicating the index, with the instruction in the ROB that corresponds to the index then marked as urgent. As such, the “means” for finding and indicating related instructions in the ROB may rely on underlying functionality that is already in the microprocessor 10 for handling scheduling and out-of-order program execution. Only very minor additional functionality need be added for exploiting the back-pointer and renaming map table—e.g., see the UIM circuitry 20-2 in the renaming unit 48 shown in FIG. 3, along with the UM circuitry 80-4 in or associated with the ROB 70, for marking unexecuted instructions in the ROB 70 that are related to a given memory instruction in the renaming unit 48.

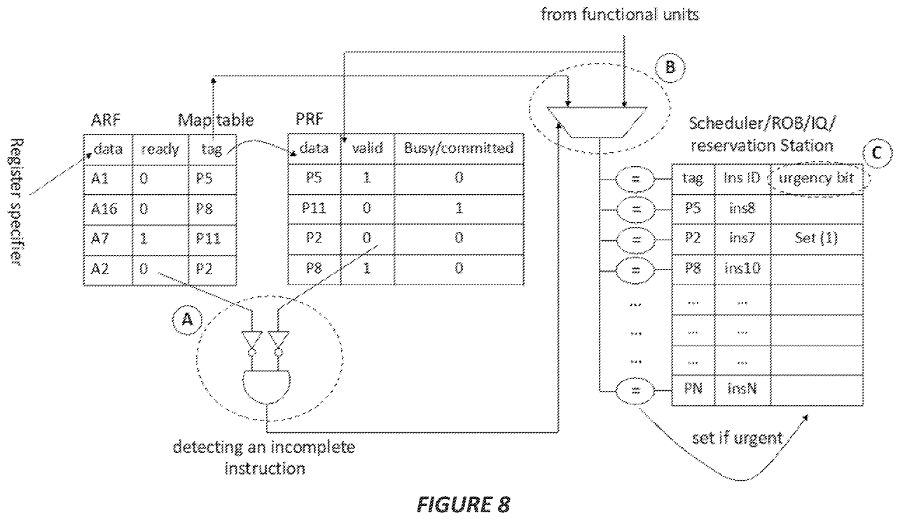

Turning back to FIG. 7, if, for example, ins127 in the ROB also contributes an address needed for the MEM instruction, the renaming map tracks that dependency and an urgency bit of ins127 is set, for prioritization of its execution, unless it has been executed. FIG. 8 illustrates a back-pointer arrangement that includes features for determining whether a related instruction in the ROB 70 has been executed.

Assume the presence of a memory instruction the renaming stage of the instruction pipeline 12 and assume that the pipeline 12 is configured to identify related instructions in the renaming stage and further in the ROB 70. That is, the process of identifying instructions that are related to memory instructions “spans” the program distance of the instruction window represented by the overall pipeline 12. However, there remains the issue of whether related instructions in the ROB 70 have been executed or are awaiting execution. Only in the latter case does urgency marking have any effect.

Circuitry shown as Items “A” and “B” in FIG. 8 provide an elegant mechanism for detecting whether an instruction in the ROB 70 that has been identified as being related to a memory instruction in the renaming stage is awaiting execution or has already executed. The circuitry relies on the “Ready” bit maintained in the renaming mapping table for renamed instructions and on the “Valid” bit maintained in the PRF 52 for in-flight instructions. When the states of those two bits, which are controlled as part of out-of-order execution processing, indicate that a related instruction held in the ROB 70 has not been executed, an urgency bit is set for the involved instruction—shown in the ROB 70 as “ins7”—is set.

While the circuitry shown as Item A is an AND gate driven by the inverse of the “Ready” bit in the register renaming table for the involved instruction and the corresponding “Valid” bit in the PRF 52, other schemes may be used, and the logic “polarity” or “sign” may be different in dependence on which states are used to indicate the executed/non-execution conditions. The circuitry shown as Item B avoids “collisions” that might otherwise arise from reusing the microprocessor's back-pointer and tag-comparison mechanisms.

In the example depiction of FIG. 8, the address “ins7” in the ROB 70 can be understood as a related instruction regarding a MEM instruction currently in the renaming stage of the pipeline 12. However, ins7 has already been renamed and dispatched and is awaiting execution. According to the illustrated example, ins7 reads from architecture register A2 which has been renamed to P2. According to the Ready bit, A2 is not ready yet and also p2 is not valid according to the Valid bit. In turn, those bit states mean that ins7 has not been executed therefore, it can be prioritized. The tag associated with the instruction is sent to the scheduling circuitry 16 for comparison. Already available hardware for renaming/back-pointing between the scheduling circuitry 16 and the ROB 70 may be exploited for such comparisons.

Here, the tag of ins7 is compared with all the entries of the scheduler (regardless of the implementation of ROB, reservation station, or IQ, such tags and comparators exist in support of renaming and out-of-order execution). The third entry—tag P2—of the scheduler matches the tag of ins7 and accordingly, the urgency bit of that entry is set.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1-19. (canceled)

20. A microprocessor comprising:
front-end circuitry of an instruction pipeline of the microprocessor, the front-end circuitry configured to fetch instructions, decode instructions, perform register renaming in association with instructions, and dispatch instructions for scheduled execution, and wherein the front-end circuitry is further configured to set an urgency indicator for each instruction identified during decoding as a memory instruction and set urgency indicators for related instructions identified during register renaming, execution of each related instruction being necessary for execution of the memory instruction; and
scheduling circuitry of the instruction pipeline, the scheduling circuitry configured to control out-of-order instruction execution of instructions dispatched by the front-end circuitry, in dependence on the urgency indicators.

21. The microprocessor of claim 20, wherein, with respect to any particular memory instruction identified during decoding, the related instructions comprise any instructions within a defined program distance from the particular memory instruction that produce a result that is needed directly or indirectly for execution of the particular memory instruction.

22. The microprocessor of claim 21, wherein the program distance is at least the width of a register renaming unit included in the front-end circuitry, such that the front-end circuitry is configured to look for related instructions at least within the register renaming unit.

23. The microprocessor of claim 21, wherein the program distance extends to instructions already dispatched by the front-end circuitry and held in a reorder buffer used by the scheduling circuitry for the out-of-order program execution, and wherein the front-end circuitry is configured to set urgency indicators for instructions in the reorder buffer that are identified as related instructions for the particular memory instruction and are determined to be pending for execution.

24. The microprocessor of claim 20, wherein load/store instructions are a type of memory instructions, such that the front-end circuitry is configured to set an urgency indicator for each load/store instruction identified during decoding, and to set urgency indicators for each instruction identified by the front-end circuitry as being related.

25. The microprocessor of claim 20, wherein storage elements used by the scheduling circuitry for holding instructions for out-of-order program execution are common between instructions having set urgency indicators and instructions having cleared urgency indicators, and wherein the scheduling circuitry is configured to consider whether instructions have set or cleared urgency indicators when scheduling instructions for out-of-order execution.

26. The microprocessor of claim 20, wherein the urgency indicators each comprise one or more bits that are selectively set for respective instructions in the pipeline, and where the front-end circuitry is configured to clear or not set a corresponding one of the urgency indictors for a particular instruction not identified as urgent, and to set a corresponding one of the urgency indictors for another particular instruction identified as urgent.

27. The microprocessor of claim 20, wherein the urgency indicators are multi-bit indicators, and wherein, with respect to setting the urgency indicator for an instruction identified as urgent, the front-end circuitry is configured to set the urgency indicator to one of multiple defined values, to indicate a degree of urgency, and wherein the scheduling circuitry is configured to consider the degree of urgency during scheduling.

28. The microprocessor of claim 20, wherein, for each memory instruction identified during decoding, the front-end circuitry is configured to set urgency indicators for all instructions that are identified as being related to the memory instruction and have a program distance from the memory instruction that is within the program distance spanned by a register renaming unit of the front-end circuitry or within the program distance spanned by a reorder buffer used by the scheduling circuitry for out-of-order execution.

29. An apparatus comprising the microprocessor according to claim 20.

30. The apparatus of claim 29, wherein the apparatus is one of: a smartphone, a personal computer, and a tablet.

31. A method performed by a microprocessor, the method comprising:
identifying memory instructions during decoding of instructions fetched into an instruction pipeline of the microprocessor for scheduling and corresponding out-of-order execution, and setting urgency indicators for the memory instructions;
for each memory instruction, identifying related instructions during register renaming and setting urgency indicators for the related instructions, wherein an instruction is related to a memory instruction if execution of the instruction is necessary for execution of the memory instruction;
dispatching instructions after decoding and register renaming, for scheduling of out-of-order execution; and
controlling the out-of-order execution of dispatched instructions, in dependence on the urgency indicators.

32. The method of claim 31, wherein, with respect to any particular memory instruction identified during decoding, the related instructions comprise any instructions within a defined program distance from the particular memory instruction that produce a result that is needed directly or indirectly for execution of the particular memory instruction.

33. The method of claim 32, wherein the program distance is at least the width of a register renaming unit included in the instruction pipeline, such that the identifying of related instructions occurs at least within the register renaming stage of the instruction pipeline.

34. The method of claim 32, wherein the program distance extends to instructions already dispatched for execution and held in a reorder buffer used by scheduling circuitry of the instruction pipeline for the out-of-order program execution, and the identifying of related instructions includes identifying related instructions in the reorder buffer that are pending for execution.

35. The method of claim 31, wherein identifying memory instructions comprises identifying load/store instructions and identifying related instructions comprises instructions on which the load/store instructions depend.

36. The method of claim 31, wherein storage elements used by scheduling circuitry of the instruction pipeline for holding instructions for out-of-order program execution are common between instructions having set urgency indicators and instructions having cleared urgency indicators.

37. The method of claim 31, wherein the urgency indicators are multi-bit indicators, such that setting the urgency indicator for an instruction identified as urgent comprises setting the urgency indicator to one of multiple defined binary values, to indicate a degree of urgency.

38. The method of claim 31, wherein, for each memory instruction identified during decoding, the method further includes setting urgency indicators for all instructions that are identified as being related to the memory instruction and have a program distance from the memory instruction that is within the program distance spanned by a register renaming unit of the instruction pipeline or within the program distance spanned by a reorder buffer used in the instruction pipeline for out-of-order execution.
